(19) United States
(12) Patent Application Publication
(10) Pub. No.: US 2006/0276249 A1
(43) Pub. Date: Dec. 7, 2006

(54) Steering shaft

(76) Inventor: Manfred Heintschel, Schwaebisch Gmuend (DE)

Correspondence Address: KENYON & KENYON LLP, ONE BROADWAY, NEW YORK, NY, 10004, US

(21) Appl. No.: 11/435,101

(22) Filed: May 15, 2006

(30) Foreign Application Priority Data
May 14, 2005 (DE) 10 2005 022 474.1

(51) Int. Cl. F16D 3/00

(52) U.S. Cl. 464/118

(57) ABSTRACT

A steering shaft, e.g., for a motor vehicle, is for mechanically linking a steering handle to a steered wheel in a torque-locked manner, the steering shaft including a first shaft and a second shaft, and the shafts being connected in a torque-locked manner via a mechanically movable universal joint (5). In order to provide a steering shaft, which allows a large, variable joint angle, while having a simple, inexpensive design, and while preventing rotational irregularities, it is provided that the mechanically movable, universal joint is arranged as a homokinetic, double universal joint, which includes an inner double fork, and a first outer joint fork and a second outer joint fork on the first and second shafts. The outer joint forks are connected to the double fork by universal joints, respectively, and include ball pins on their ends pointing toward the double fork, by which these engage with a guideway on an axially nondisplaceable, but radially displaceable centering disk in the double fork.

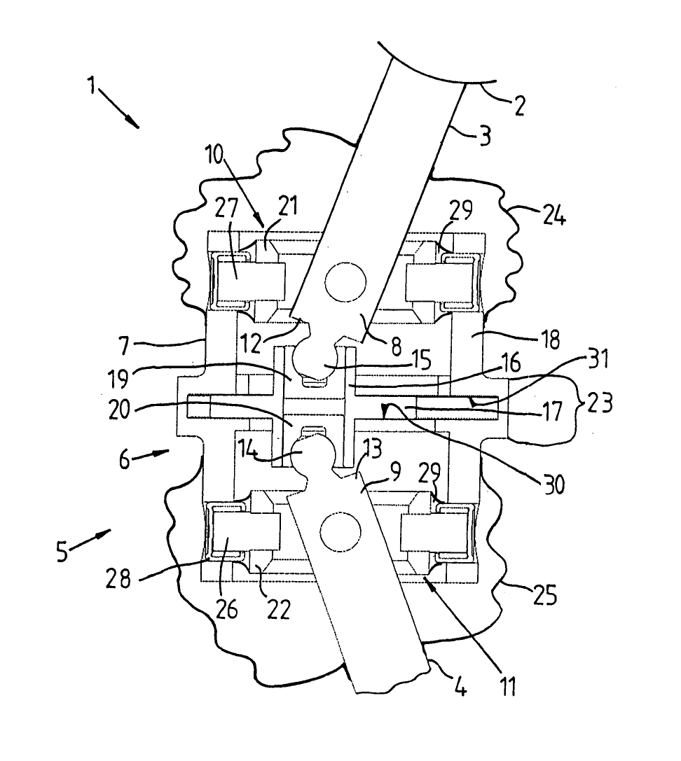

### CROSS-REFERENCE TO RELATED APPLICATIONS

The present application claims priority to Application No. 10 2005 022 474.1, filed in the Federal Republic of Germany on May 14, 2005, which is expressly incorporated herein in its entirety by reference thereto.

### FIELD OF THE INVENTION

The present invention relates to a steering shaft, e.g., for a motor vehicle.

### BACKGROUND INFORMATION

Steering shafts for a torque-locked, mechanically-linked connection of a steering handle or a steering wheel to a steered wheel are believed to be conventional, where the path of shaft parts of the steering shafts is angular. In the steering train formed in this manner, the shafts are connected to each other or also to a steering gear or angle drive by mechanically movable joints, such as universal joints. For example, German Published Patent Application No. 40 00 994 or Japanese Published Patent Application No. 11-43050 describes a steering shaft for mechanically linking a steering handle to a steered wheel in a torque-locked manner, angle drives or single universal joints being used for joining the individual components of the steering shaft.

Such single universal joints are believed to be considerably limited with respect to their joint angle and are believed to exhibit rotational irregularities in operation. In order to angle a steering shaft sharply, it is necessary to divide the steering shaft up several times into shaft sections, which must be connected by universal joints. If an angle drive is used to produce a large angle, for example, 90°, in the steering shaft, this entails a corresponding loss of efficiency. In addition, the joint angle of such a steering shaft is fixed and not variably selectable and not adaptable to different types of vehicles. Conventional design approaches for producing a joint angle in a steering shaft are expensive or limited to a fixed joint angle.

### SUMMARY

Example embodiments of the present invention may provide a steering shaft, which may allow a large, variable joint angle, while having a simple, inexpensive design, and while preventing rotational irregularities of the steering shaft.

Since the mechanically movable universal joint takes the form of a homokinetic double joint or double universal joint, which includes an inner double fork and a first and second outer joint fork that are each connected to the double fork by a universal joint or spider, where the ball pins of the outer joint forks engage with a guideway on the ends of the joint forks pointing toward the double fork, and the guideway is fixed to an axially immovable and radially displaceable centering disk supported in the double fork, a mechanically movable universal joint that is simple to construct is positioned in the steering shaft, which is consequently provided with a variable overall joint angle that may be 70° or more. The steering shaft transmits rotational movements between the first and second shafts without rotational irregularities.

The centering disk is positioned in the double fork such that it may move in its own plane, which coincides with the specific plane of symmetry of the first and second shafts. The angling of the first and second shafts with respect to the double fork may take place in any direction.

The double fork may take the form of a sleeve-shaped, e.g., cylindrical, solid-walled coupling cage, or the form of a housing that may be axially symmetric about its longitudinal axis.

The ball pins at the ends of the outer joint forks each engage with a ring bearing or a cylindrical bearing sleeve having a hollow-spherical bore, which corresponds to the spherical shape of the ball pins, and in which the ball pin is universally pivoted. The ring bearings or bearing sleeves have a cylindrical outer surface, by which the bearing sleeves are guided in an axially movable manner in the guideway on the centering disk. While the centering disk having the guideway may me made out of a non-ferrous metal, such as brass, it may be provided to make the bearing sleeves out of a thermoplastic or thermoset, low-wear resin, which may also be fiber-reinforced. It may also be provided to make the centering disk out of a thermoplastic or thermoset resin.

The universal joints may take the form of trunnion rings, which are supported by needle-bearing sleeves in the inner double fork or the coupling cage or the housing and allow a cardanic connection of the first and second shafts to the double fork. The centering disk and the guideway for the bearing sleeves that extends perpendicularly to the mid-plane of the centering disk, on or toward both sides, may be manufactured in one piece with the centering disk.

The centering disk is supported and guided in a radially movable manner in a bearing-housing section of the double fork or the coupling cage or the housing, e.g., on two guide disks or guide plates forming an axial end stop for the centering disk. The bearing-housing section, but at least the guide disks or guide plates, may be made of a material different from that of the centering disk.

The homokinetic, double universal joint may be sealed by bellows, which extends from the ends of the first and second shafts pointing toward the double fork, onto the double fork or the coupling cage or the housing. The joint angle of the homokinetic, double universal joint may allow the steering shaft to angle up to 90°. The homokinetic, double universal joint may be arranged in a driver's-compartment wall, e.g., in the firewall of a motor vehicle, or arranged at any position in the steering shaft, in single or multiple form.

The steering shaft may be telescopic on one or both sides, the homokinetic, double universal joint being able to be installed at any position of the steering shaft, and consequently, on an end of the steering shaft as well.

Nevertheless, the homokinetic, double universal joint may be integrated in an adjustable steering-shaft arrangement, the position of the steering shaft being arranged to be variable relative to a bearing block fixed to the vehicle, using a steering-shaft retaining device. The wide joint-angle range and the compact arrangement of the steering shaft may allow this. The device for fixing the position of the steering-shaft retaining device and/or of the steering shaft may be situated inside the bearing block, since the steering shaft is constructed in a compact manner. Thus, many different types of devices for setting the position of the steering-shaft retaining device, such as electric, pneumatic, hydraulic, mechanical, etc., may also be arranged in the bearing block.

According to an example embodiment of the present invention, a steering shaft for mechanically linking a steering handle to a steered wheel in a torque-locked manner includes: a mechanically movable universal joint; a first shaft; and a second shaft connected in a torque-locked manner with the first shaft by the mechanically movable universal joint. The mechanically movable universal joint is arranged as a homokinetic, double universal joint including an inner double fork, a first outer joint fork and a second outer joint fork on the first and second shafts, the outer joint forks connected to the inner double fork by respective universal joints and including ball pins on ends of the outer joint forks pointing toward the inner double fork, the outer joint forks engaging with a guideway on an axially nondisplaceable, radially displaceable centering disk in the double fork by the ball pins.

The steering shaft may be arranged as a steering shaft for a motor vehicle.

The inner double fork may be arranged as one of (a) a coupling cage and (b) a housing.

Each ball pin may be supported in the guideway in an axially displaceable manner by a bearing sleeve.

At least one of (a) the bearing sleeves and (b) the centering disk may be made of one of (a) a thermoplastic resin and (b) a thermoset resin.

At least one of (a) the bearing sleeves and (b) the centering disk may be made of a fiber-reinforced plastic resin.

The universal joints may be arranged as trunnion rings.

The centering disk and the guideway may be integrally formed.

The centering disk may be radially displaceable supported in a bearing-housing section in the inner double fork, and the bearing-housing section may be formed of a material different from a material of the centering disk.

The steering shaft may include bellows extending from the ends of the first and second shafts to the inner double fork.

The homokinetic, double universal joint may be adapted to permit an angle of the first shaft relative to the second shaft up to approximately 90°.

Example embodiments of the present invention are described in more detail below with reference to the appended FIGURES.

### BRIEF DESCRIPTION OF THE DRAWING

The FIGURE is a partial longitudinal cross-sectional view of a steering shaft according to an example embodiment of the present invention.

### DETAILED DESCRIPTION

A partial longitudinal cross-sectional view of a steering shaft 1 for a motor vehicle is illustrated in part in the FIGURE. Steering shaft 1 is used for connecting a steering handle 2 to a steering gear and to tie rods and wheel steering arms driven by it, in a torque-locked manner, for adjusting the steering angle of one or more steered wheels of the motor vehicle. In order to arrange steering shaft 1 to be adjustable with regard to the option of building it into many different types of vehicles and their driver's compartments, a mechanically movable shaft joint 5, which takes the form of a homokinetic, double universal joint 6, is provided between a first shaft 3 and a second shaft 4 of steering shaft 1. First and second shafts 3, 4 are connected to homokinetic, double universal joint 6 in a torque-locked manner, so as to have a possible joint angle of up to 90°. Homokinetic, double universal joint 6 is arranged to prevent rotational irregularities between first and second shafts 3, 4. Homokinetic, double universal joint 6 may also be arranged on a shaft stem of steering column 1.

Homokinetic, double universal joint 6 includes an inner double fork 7, which takes the form of a cylindrical housing 18 and transmits the torque between first and second shafts 3, 4. On their ends 12, 13 that each face inner double fork 7, first and second shafts 3, 4 have a first and a second outer joint fork 8, 9, which are connected to inner double fork 7 in a torque-locked manner via universal joints 10, 11, respectively, which, in the exemplary embodiment illustrated, include trunnion rings 10, 11. Roller bearings, which may take the form of needle-bearing sleeves 28, are mounted on trunnions 26, 27 of trunnion rings 21, 22. They may be sealed with respect to housing 18, using sealing rings 29. Ball pins 14, 15, whose spherical outer surfaces each engage with a hollow-spherical bore of a bearing sleeve 19, 20, are arranged on the two ends 12, 13 of outer joint forks 8, 9. Bearing sleeves 19, 20 have cylindrical outer surfaces, by which they are supported in a guideway 16 on a centering disk 17 so as to be able to slide. In a bearing-housing section 23 open radially inwardly, centering disk 17 is supported axially non-displaceably, but radially, between guide surfaces 30, 31, in housing 18 or inner double fork 7. Guide surfaces 30, 31 are made, for example, out of an aluminum alloy, while centering disk 17 may be made out of a brass alloy. It may also be provided to make centering disk 17, guide surfaces 30, 31, and/or bearing-housing section 23 out of a hardened steel, or to make centering disk 17, guide surfaces 30, 31 and/or bearing-housing section 23 out of a thermoplastic resin or thermoset resin, which may also be fiber-reinforced.

The mode of operation of homokinetic, double universal joint 6 is as follows: at any joint angle between outer joint forks 8, 9, inner double fork 7, which interconnects universal joints 10, 11 of outer joint forks 8, 9, is automatically supported in a central position with respect to the two outer joint forks 8, 9, so that ball pins 14, 15 of outer joint forks 8, 9, together with guideway 16 on centering disk 17, bring about an exact angle bisection. This provides a homokinetic method of operation at any possible joint angle. In response to the rotation of homokinetic, double universal joint 6, centering disk 17 moves in the annular gap at bearing-housing section 23, between guide surfaces 30, 31. Homokinetic, double universal joint 6 may be sealed with respect to the outside by bellows 25, which extend from the two outer joint forks 8, 9 over housing 18. Homokinetic, double universal joint 6 includes a few component parts, which are easily represented.

### LIST OF REFERENCE NUMERALS

1 steering shaft
2 steering handle
3 first shaft
4 second shaft
5 mechanically movable universal joint
6 homokinetic, double universal joint
7 inner double fork
8 first outer joint fork
9 second outer joint fork
10 universal joint
11 universal joint
12 end
13 end
14 ball pin
15 ball pin
16 guideway
17 centering disk
18 housing
19 bearing sleeve
20 bearing sleeve
21 trunnion ring
22 trunnion ring
23 bearing-housing section
24 bellows
25 bellows
26 trunnion
27 trunnion
28 needle-bearing sleeve
29 sealing ring
30 guide surface
31 guide surface

What is claimed is:

1. A steering shaft for mechanically linking a steering handle to a steered wheel in a torque-locked manner, comprising:
a mechanically movable universal joint;
a first shaft; and
a second shaft connected in a torque-locked manner with the first shaft by the mechanically movable universal joint;
wherein the mechanically movable universal joint is arranged as a homokinetic, double universal joint including an inner double fork, a first outer joint fork and a second outer joint fork on the first and second shafts, the outer joint forks connected to the inner double fork by respective universal joints and including ball pins on ends of the outer joint forks pointing toward the inner double fork, the outer joint forks engaging with a guideway on an axially nondisplaceable, radially displaceable centering disk in the double fork by the ball pins.

2. The steering shaft according to claim 1, wherein the steering shaft is arranged as a steering shaft for a motor vehicle.

3. The steering shaft according to claim 1, wherein the inner double fork is arranged as one of (a) a coupling cage and (b) a housing.

4. The steering shaft according to claim 1, wherein each ball pin is supported in the guideway in an axially displaceable manner by a bearing sleeve.

5. The steering shaft according to claim 4, wherein at least one of (a) the bearing sleeves and (b) the centering disk is made of one of (a) a thermoplastic resin and (b) a thermoset resin.

6. The steering shaft according to claim 5, wherein at least one of (a) the bearing sleeves and (b) the centering disk is made of a fiber-reinforced plastic resin.

7. The steering shaft according to claim 1, wherein the universal joints are arranged as trunnion rings.

8. The steering shaft according to claim 1, wherein the centering disk and the guideway are integrally formed.

9. The steering shaft according to claim 1, wherein the centering disk is radially displaceable supported in a bearing-housing section in the inner double fork, the bearing-housing section formed of a material different from a material of the centering disk.

10. The steering shaft according to claim 1, further comprising bellows extending from the ends of the first and second shafts to the inner double fork.

11. The steering shaft according to claim 1, wherein the homokinetic, double universal joint is adapted to permit an angle of the first shaft relative to the second shaft up to approximately 90°.
